(19) United States
(12) Patent Application Publication
(10) Pub. No.: US 2003/0177126 A1
(43) Pub. Date: Sep. 18, 2003

(54) Volume weighted average price system and method

(76) Inventors: Fred S. Weingard, Ambler, PA (US); William A. Lupien, Hesperus, CO (US); Rondal C. Ellifritt, New York, NY (US); Trevor B. Price, New York, NY (US); Kevin L. Sluder, Portsmouth, NH (US); Joseph Franchi, Plainsboro, NJ (US); Roy Neff, King of Prussia, PA (US); Justin L. Turner, Philadelphia, PA (US)

Correspondence Address: CUMMINGS & LOCKWOOD, Four Stamford Plaza, P.O. Box 120, Stamford, CT, 06904-0120, US

(21) Appl. No.: 10/252,783

(22) Filed: Sep. 23, 2002

Related U.S. Application Data
(60) Provisional application No. 60/323,940, filed on Sep. 21, 2001.

(51) Int. Cl. G06F 7/00

(52) U.S. Cl. 707/10

(57) ABSTRACT

The present disclosure provides automated systems and methods that facilitate consummation of Volume Weighted Average Price (“VWAP”) transactions and that support crossing of offsetting orders, cancellation of orders and enhanced liquidity for system users. Exemplary embodiments of the present disclosure provide a pre-open crossing network, an approximation engine and an intra-day crossing network. A processing engine is provided that is in communication with an algorithmic module and a database which advantageously includes a liquidity database. The processing engine is programmed to automatically access the liquidity database to determine an acceptable quantity of shares for trading in response to, and based upon, a requested user trade received by the processing engine. The algorithmic module includes programming for establishing a trading regimen for effecting trades that approach or achieve a VWAP price for best efforts VWAP trades.

### 1. CROSS-REFERENCE TO RELATED APPLICATIONS

The present application claims the benefit of a provisional patent application filed in the United States Patent and Trademark Office on Sep. 21, 2001, entitled “Volume Weighted Average Price System and Method” and assigned Serial No. 60/323,940, the entire contents of which are hereby incorporated by reference

### BACKGROUND OF THE DISCLOSURE

### 2. COPYRIGHT NOTICE

A portion of the disclosure of this patent document contains material which is subject to copyright protection. The copyright owner has no objection to the facsimile reproduction by anyone of the patent document or patent disclosure as it appears in a Patent Office, patent file or records, but otherwise reserves all copyright rights whatsoever.

3. Technical Field

The present disclosure is directed to automated systems and methods for consummating Volume Weighted Average Price (“VWAP”) transactions and, more particularly, to automated systems and methods that support crossing of offsetting orders, cancellation of orders and enhanced liquidity for system users. Exemplary embodiments of the present disclosure offer a pre-open crossing network, an approximation engine and/or an intra-day crossing network. Each of the above-noted aspects of the present disclosure provide advantageous results, whether implemented alone or in combination with one or more of the other aspects hereof, as will be apparent from the detailed description which follows.

4. Background Art

Traditionally, traders and investors who desired to buy or sell securities placed orders with brokers who traded on the floor of organized stock exchanges, such as the New York Stock Exchange or the NASDAQ market. Traders and investors, particularly institutional investors, are increasingly balking at the high cost of trading on organized exchanges and in the OTC (Over-The-Counter) market. Discontent with the expense of using intermediaries and the cost of market impact has contributed to the development of the electronic fourth market for crossing trades. See “Reshaping the Equity Markets, A Guide for the 1990s” by Robert A. Schwartz, Harper Business, 1991, especially at pp. 93-95.

Various companies and exchanges operate computerized crossing networks, also called anonymous matching systems. In an anonymous matching system, the identity of the source of an order (e.g., the name of a trader or firm submitting the order) is not disclosed to other traders. By way of example, crossing networks used in connection with the trading of trading instruments are disclosed in U.S. Pat. No. 4,412,287, which discloses an automated stock exchange in which a computer matches buy and sell orders for a variety of stocks; U.S. Pat. No. 3,573,747, which discloses an anonymous trading system for selling fungible properties between subscribers to the system; U.S. Pat. No. 3,581,072, which discloses the use of a special purpose digital computer for matching orders and establishing market prices in an auction market for fungible goods; U.S. Pat. No. 4,674,044, which discloses an automated securities trading system; U.S. Pat. No. 5,136,501, which discloses an anonymous matching system for effectuating trades through automatic matching in which buyers and sellers who are willing to trade with one another based on specified criteria, such as price, quantity and credit, may automatically trade when matching events occur satisfying these criteria; and U.S. Pat. No. 5,101,353, which discloses an automated system for providing liquidity to securities markets in which orders are entered by the system and executed in real time either internally between system users or externally with stock exchanges and markets.

Crossing networks have a number of advantages, including: (a) traders need not search for a contra party; and (b) anonymity is preserved. Existing facilities for crossing trades include Instinet's Crossing Network and POSIT (Portfolio System for Institutional Trading) which is jointly owned by Jefferies and BARRA. The Instinet Crossing Network has an equities trading service to match buyers and sellers anonymously at set times. Computers pair buyers with sellers on a time priority basis. Trades are executed at the closing price for exchange-listed issues, and at the midpoint of the inside market (best bid and ask) for OTC issues.

POSIT, for example, enables large investors to trade baskets of stocks among themselves. The orders are sent to a central computer where they are electronically matched with other orders. Unlike Instinet's Crossing Network, POSIT crosses are done during the trading day. The prices are obtained from those quoted on the exchanges, a practice known as “parasitic pricing.” See “Reshaping the Equity Markets, A Guide for the 1990s” cited above.

Instinet, owned by Reuters, also operates an electronic block-trading system that facilitates the negotiation of block trades between institutional investors and brokers. Instinet allows parties to trade anonymously, entering bids electronically. Instinet subscribers can respond to an “order” entered into the system either by matching a displayed price or by making a counter bid or offer that is transmitted instantaneously to the contra party's terminal. The trades that result from these negotiations become public information only when they are executed. This procedure provides an alternative to the direct human-to-human negotiation of orders in the upstairs market or on the trading floors. Instinet provides a limit order book for over-the-counter (OTC) securities and listed securities and also provides inside quotes for exchange listed securities for the seven U.S. exchanges on which stocks can be traded and for NASDAQ listed securities.

Many crossing networks function independently of existing stock exchanges. However, some crossing networks are operated by stock exchanges. For example, the Match Market Exchange (“MMX”) had been operated by the Chicago Stock Exchange. All matched orders were executed at a random time within a predetermined ten minute window at the market price at such time. The market price was calculated based upon the spread of a particular issue. Rather than matching orders on the basis of time priority, the MMX system used liquidity fees and liquidity credits to determine the level of priority for order matching. Those users willing to pay the highest liquidity fee had the highest execution priority. See 59 F.R. 5451 (Feb. 4, 1994).

Crossing networks that automatically match buy and sell orders often concentrate trading at a single point of time, and can be called a batch process matching system. There is a need, however, for an anonymous crossing network that continuously, and in real-time, satisfies the buying and selling desires of an arbitrary number of market participants.

A major problem encountered in the design of crossing networks is that of determining how to match buyers and sellers. Existing approaches to this problem include:

a) Take-out strategies, where overlapping bids and offers are matched at the midpoint of the overlapped bid and ask prices, with priority given to buyers and sellers in order of price. This assumes a significant quantity of non-disclosed orders in the system; otherwise, there would be no incentive for overlap, and take-out would start at the disclosed best bid/offer prices, just like the Instinet book.

b) Single price auction strategies, where a single, size-weighted average price is computed from overlapping bid and offer prices, and everyone is filled at that price. Again, traders would have to be confident of a significant number of non-disclosed orders in the system to have the incentive to enter orders at a better price than the best disclosed price.

c) Premium strategies (as in the Chicago MMX system), where bids and offers have an associated positive or negative premium, and crossing takes place at the midpoint of market spread or at the minimum necessary premium differential from the midpoint, with priority given in order of premium. Here, the premium-based priority in matching provides the incentive for offering higher premiums.

Each of the above approaches is a batch process that relies upon ad hoc rules of competition among a relatively small set of discrete orders as being the means of arbitrating the crossing network participants' buy/sell entries. In the real world of trading, orders to buy or sell can enter the market at any time, and discrete orders in a crossing network often represent only an approximate and partial expression of the order fill that would satisfy the trader. For institutional traders in particular, an individual order seldom represents the full desired fill size, and the trader must then employ multiple orders at different prices (and generally in different markets) to achieve his ultimate fill.

Typically, existing crossing networks allow discrete buy or sell orders to be entered, e.g., “sell 10,000 IBM at 64.” However, as stated above many traders, particularly institutional traders, wish to deal in baskets of securities, so that, for example, a portfolio is as far as possible, “balanced.” Existing crossing networks do not easily allow traders to enter combinations of orders, such as “sell 10,000 IBM at 64 only if I can buy 20,000 DEC at 32”. Furthermore, existing crossing networks do not allow traders to enter combinations of orders, such as “sell 10,000 IBM at 64 or sell 100,000 IBM at 63.” Traders often have trading strategies such as, for example, “buy 3,000 IBM at 33, but if I can buy 5,000, I would be prepared to pay 33 and ½”, that cannot be handled by existing crossing networks.

Additional background disclosures of potential relevance to the subject matter of the present disclosure include the following: U.S. Pat. No. 4,823,265 to Nelson; U.S. Pat. No. 5,083,782 to Nilssen; U.S. Pat. No. 5,202,827 to Sober; U.S. Pat. No. 5,557,517 to Daughterty, III; U.S. Pat. No. 5,884,286 to Daughterty, III; U.S. Pat. No. 6,128,598 to Walker et al.; and U.S. Pat. No. 6,263,321 to Daughterty, III.

Notwithstanding previous efforts in the field, a need remains for automated systems and/or methods that facilitate consummation of Volume Weighted Average Price (“VWAP”) transactions and that support crossing of offsetting orders, cancellation of orders and enhanced liquidity for system users. In addition, a need remains for automated systems and/or methods that provide a pre-open crossing network, an approximation engine, and/or an intra-day crossing network having particular applicability to VWAP-related transactions.

### SUMMARY OF THE DISCLOSURE

The present disclosure provides automated systems and methods that facilitate consummation of Volume Weighted Average Price (“VWAP”) transactions and that support crossing of offsetting orders, cancellation of orders and enhanced liquidity for system users. Exemplary embodiments of the present disclosure provide a pre-open crossing network, an approximation engine and an intra-day crossing network. These and other functions and features of the automated systems and methods of the present disclosure will become more readily apparent to those having ordinary skill in the art from the detailed description of the subject disclosure which follows.

Each of the disclosed aspects of the present disclosure, including specifically the crossing of offsetting orders, cancellation of orders, enhanced liquidity, pre-open crossing network, approximation engine, and an intra-day crossing network provide advantageous results, provide advantages and benefits to operators and/or users thereof, whether implemented alone or in combination with one or more of the other systems and/or methods. Accordingly, the present disclosure is not limited to automated systems and/or methods that include all, or some defined subset, of the advantageous functions, features, advantages or benefits disclosed herein.

According to an exemplary system of the present disclosure, a processing engine is provided that is in communication with an algorithmic module and a database. The database advantageously includes a liquidity database. The processing engine is programmed to automatically access the liquidity database to determine an acceptable quantity of shares for trading in response to, and based upon, a requested user trade received by the processing engine. Requested user trades are generally communicated to the processing engine across a network interface, e.g., over the Internet, using a predetermined protocol, e.g., the FIX protocol. The algorithmic module typically includes programming for establishing a trading regimen for effecting trades that approach or achieve a VWAP price for best efforts VWAP trades.

Requested user trades are generally communicated to the processing engine in a predetermined format that includes an identification of a trading action, a trading symbol, a trading price, a cancel option and a trading session. In the event a cancel option and/or a trading session are not specified, the processing engine automatically applies a default value, e.g., based on user-specific information contained in a database associated with the processor. In the absence of an identified trading session, the processing engine may automatically implement the requested trade in the next upcoming session.

The processing engine of the disclosed system is typically programmed to automatically aggregate requested user trades based upon the security to be traded, and automatically crosses user trades to the extent possible. The processing engine advantageously provides guaranteed VWAP pricing based upon a trading determination derived from information contained in the liquidity database. The liquidity database is typically updated to reflect completed user trades and, in exemplary embodiments, is further revised based on one or more external factors, e.g.,. historical market data for the shares of interest, historical trading performance with respect to the shares of interest, time remaining in the trading session, time remaining in the trading day, and the like.

The disclosed processing engine automatically processes trades during predetermined trading sessions of predetermined duration. In a preferred embodiment of the present disclosure, ten trading sessions of fifteen minutes duration are effectuated during a typical trading day. The requested user trade generally identifies a desired trading session from among the available trading sessions for execution thereof.

The disclosed system is further typically programmed such that the processing engine automatically processes a cancellation request received in connection with a requested user trade. However, the processing engine generally processes the cancellation request only if it is received a predetermined period of time prior to commencement of the desired or identified trading session.

According to the present disclosure, an advantageous method for processing a user trade is also provided. The method generally includes the steps of:

(a) enrolling a user for utilization of a processing engine, the enrollment including storage of relevant enrollment information in an enrollment database;

(b) receiving a requested user trade from an enrolled user in a predetermined format;

(c) automatically determining a quantity of shares that may be traded at a VWAP price in response to the requested user trade based upon information derived from a liquidity database; and

(d) filling a quantity of shares at the VWAP price based upon the liquidity database-based determination.

The enrollment step generally includes a credit risk determination with respect to a potential enrollee. The method further generally includes algorithmically determining a trading regimen for a quantity of shares that are not filled at the VWAP price, i.e., based upon the liquidity database-based determination. The trading regimen is typically aimed at achieving a VWAP price for the non-filled quantity of shares.

These and other features of the system and method of the present disclosure will become more readily apparent to those having ordinary skill in the art from the following detailed description taken in conjunction with the drawing appended hereto.

### BRIEF DESCRIPTION OF FIGURE

So that those having ordinary skill in the art to which the subject disclosure pertains will more readily understand how to make, use and operate the systems and methods of the subject disclosure, exemplary embodiments will be described herein with reference to the following figures, wherein:

FIG. 1 is a schematic block diagram showing components and associated communications according to an exemplary system of the present disclosure.

### DETAILED DESCRIPTION OF PREFERRED EMBODIMENT(S)

The present disclosure provides automated systems and methods that facilitate consummation of Volume Weighted Average Price (“VWAP”) transactions. Exemplary systems and methods according to the present disclosure advantageously support crossing of offsetting orders, cancellation of orders and enhanced liquidity for system users. Exemplary embodiments further provide a pre-open crossing network, an approximation engine, and an intra-day crossing network. Each of the noted aspects of the present disclosure provide advantages and benefits to operators and/or users thereof, whether implemented alone or in combination. Thus, as will be apparent to persons skilled in the art, the present disclosure is not limited to automated systems and/or methods that include all, or some defined subset, of the advantageous functions, features, advantages or benefits disclosed herein.

The present disclosure is described below in the context of trading equity securities. However, the disclosure is not so limited and can be easily adapted to allow the trading of anything that can be bought or sold, including liquid assets such as futures, derivatives, options, bonds, currencies, commodities, insurance contracts, and the like. Accordingly, where the context permits, the terms “securities”, “stock”, and “shares” when used herein includes other instruments that can be traded, such as, for example, futures, derivatives, options, bonds and currencies. Similarly, the terms “buy” and “sell” include, where appropriate, put and call, bid and offer, etc.

Intended users of the representative embodiment system of the system/method of the present disclosure are typically investors, such as institutional investors (e.g., a pension fund), individual investors, brokers or others who deal in or trade securities. As used herein, the term “user”, “trader” or “investor” means that person or entity who wishes to make a trade.

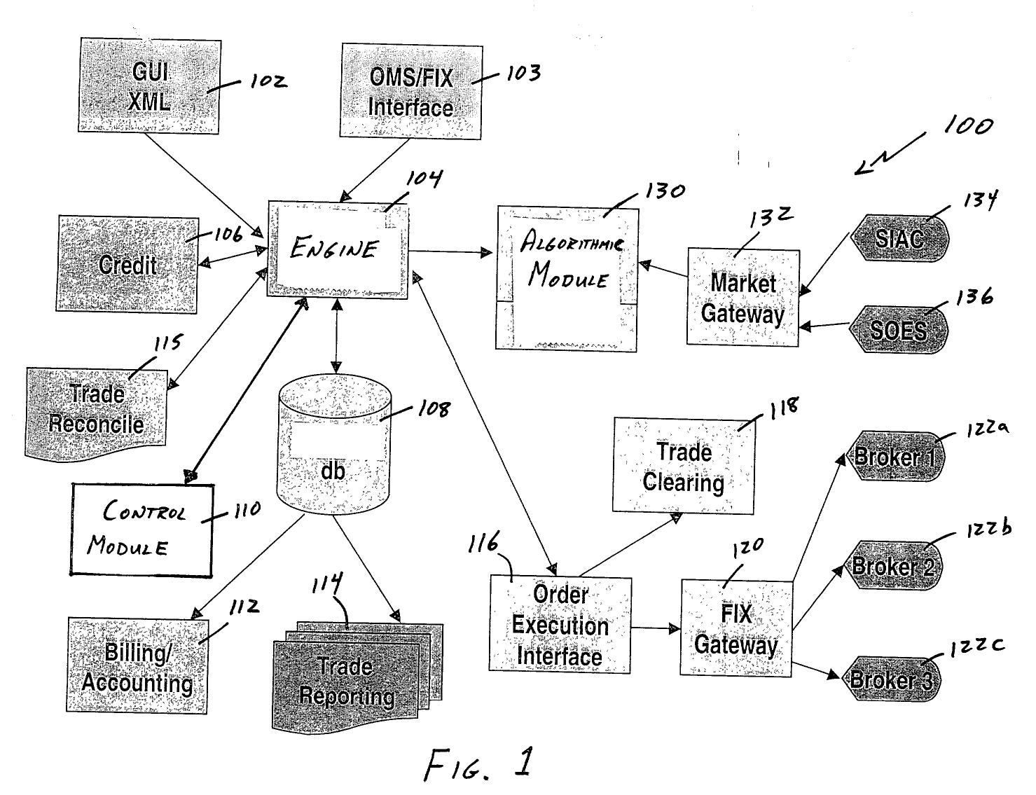

With reference to FIG. 1, a schematic block diagram is provided showing exemplary communications associated with a system or method of the present disclosure. According to the overall communication scheme 100, a graphical user interface 102 and/or an OMS/FIX interface 103 facilitate communication of buy and sell orders by system users to a “central order book” or engine 104. According to exemplary embodiments of the present disclosure, system users are enrolled and activated prior to becoming eligible to enter orders directly into engine 104 (or to send orders to order entry handlers who communicate such orders to engine 104 on the user's behalf). Thus, a preferred enrollment procedure involves, inter alia, an appropriate credit check utilizing conventional credit assessment resource(s) 106, as are known in the art. In addition, an enrolled user seeking to enter an order with engine 104 may be subjected to a further credit check, e.g., using credit assessment resource(s) 106, to ensure that the user continues to satisfy applicable credit risk requirements. Prerequisites for enrollment and/or order placement with engine 104 by a potential system user are generally predetermined by the system operator, and stored in database 108 for communication with engine 104 to determine satisfaction thereof in real time.

Exemplary embodiments of the disclosed system/method thus include an enrollment module that interfaces with database 108 to support enrollment and/or activation of customers and system users. The enrollment module captures customer defaults and requirements to use the system, including (but not limited to): credit limits, clearing and settlement instructions, eligible users and their respective contact information, and access mechanisms.

The design and functionality of interfaces 102, 104 is not critical to the operation and/or enhanced functionality of the disclosed system/method. Rather, both graphical user interface 102 and OMS/FIX interface 103 are preferably designed to facilitate ease, efficiency and speed of use. Interface 102 is generally network-based, e.g., designed to facilitate Internet or web-based communications, and permits access to engine 104 to enter orders, enter lists of orders, and to communicate order cancellations directly thereto.

In the case of an exemplary FIX (“Financial Information eXchange) interface 103, the FIX messaging standard may be utilized for real-time electronic exchange of securities transactions. FIX is a public-domain specification maintained by FIX Protocol, Ltd. which defines specific kinds of electronic messages for communicating securities transactions between two parties. According to preferred embodiments of the present disclosure, engine 104 is designed to communicate with users that employ the FIX protocol, which defines only the format of the messages and the session-level interaction between two applications (www.fixprotocol.org).

Control module 110 interacts with engine 104 to automatically start and turn off engine 104 based on operational criteria. In exemplary embodiments of the present disclosure, control module 110 also performs pre-start and end-of-day functions with regard to the disclosed system/method. For example, control module 110 is advantageously programmed to recognize exceptional days, such as weekends, trading holidays, ½ trading days before holidays and triple witch days, that generally benefit from special settings and special pre-start activities with respect to engine 104. Control module 110 also generally orchestrates backup and recovery, disaster recovery, and end-of-day archiving on a daily basis. Control module 110 further functions to monitor the health and well-being of the disclosed system, and creates/initiates system alerts and pages to operations staff, as needed. Although not schematically illustrated in FIG. 1, the control module 104 is also generally designed to “talk to” other modules, interfaces, database systems and the like, to ensure that all systems are “go” before allowing engine 104 to accept orders from system users.

Engine 104 provides valued liquidity to customers and/or users of the disclosed system/method. Engine 104 automatically fills customer orders with dealer-based guaranteed VWAP pricing or agency-based best-efforts VWAP pricing. In addition, as discussed in greater detail below, engine 104 advantageously supports a variety of VWAP price intervals, crossing of offsetting orders, cancellation of orders, and operation in a variety of market conditions. Engine 104 is preferably a computer that can perform calculations at rates of multiple gigaflops, such as, for example with present technology, an IBM SP2 or an Intel PARAGON supercomputer.

With particular reference to the communication of orders to engine 104, single orders or a list of orders may be communicated to engine 104 by enrolled customers. According to a preferred embodiment of the present disclosure, each order is represented by the following five pieces of information: <action, size, symbol, product, cancel_option, session_call_point>. For example, orders according to the present disclosure may be communicated as follows:

<BUY 10,000 IBM Guaranteed_VWAP, non-cancelable, 9:30 session>or

<SELL 5,430 IBM Best_Efforts_VWAP, cancelable, 11:15 session>

Session call points (“sessions”) for purposes of order execution can be every “x” minutes on the hour (e.g., every 15 minutes on the hour) during normal market hours. If the desired session is not specified within an order received by engine 104, then the next available session is generally assumed. If the order fails to specify the “product” or “cancel_option”, then they are determined/defaulted based on applicable default parameters. According to a preferred embodiment of the present disclosure, default parameters are established at the time of customer enrollment, and such customer enrollment instructions are maintained by database 108 for access by engine 104, as needed.

Orders and a lists of orders must be received by engine 104 at least “y” minutes prior to the session. The call point that is “y” minutes prior to every session is generally referred to as the “customer call point.” If an order/list of orders is received beyond the “y” minute threshold, engine 104 generally rejects such order/list of orders if the order identified the upcoming session as the target session, enters the order/list of orders for the next available session if the upcoming session was not specifically targeted.

According to the present disclosure, orders, entire lists of orders, and/or orders within lists of orders can be cancelled at anytime by the system user, provided the order was specifically identified as cancelable at the time of order entry. If the order failed to specify that such order was cancelable, engine 104 automatically rejects a user's request to cancel such order (or list of orders, in whole or in part). Orders, lists of orders and cancellations are generally processed by engine 104 on a first-come, first-serve basis, based on the timing of their receipt by engine 104. However, alternative order processing priorities may be incorporated into the disclosed system/method, if desired. Engine 104 thus accepts customer orders and subsequent cancel requests. Engine 104 further maintains session call points and customer call points, and processes orders and cancels on a first-come, first-serve with respect to these call points.

Upon receipt of an order or list of orders from a system user, the order/list of orders is typically checked by engine 104 for validity of information, e.g., tradable symbol, and for credit limit compliance based on data within the enrollment data set within database 108. Once an order is deemed valid, engine 104 generally aggregates all orders of the same symbol and “crosses” all orders on opposite sides of a symbol targeted for the same session, i.e. 150,000 to “buy” crosses with 100,000 to “sell”, leaving a net buy of 50,000. To the extent the order cannot be executed through aggregated direct “crosses” with opposing order(s), the un-filled portion of the order is matched by engine 104 against a liquidity database (e.g., within database 108) to determine how much (if any) of the order that engine 104 can “fill” at the order's specified product pricing. In making this determination, engine 104 is programmed to determine the degree to which filling the order at the specified price will affect applicable net capital requirements and overall credit limits associated with regulatory compliance and applicable business parameters associated with operation of the disclosed system/method.

According to advantageous aspects of the present disclosure, the disclosed system/method is able to provide a user with “guaranteed VWAP pricing” to the extent engine 104 fills the order at the specified price based on matching within the liquidity database. To the extent engine 104 is unable to fill the order at the specified price based on liquidity database matching, the user generally receives “best efforts VWAP pricing, as described in greater detail below. Engine 104 thus minimizes net capital haircuts, thereby maximizing liquidity to system users.

VWAP (“volume weighted average price”) trading, which has grown in interest in both U.S. and international markets, generally involves submission of unpriced bids or offers (which may include minimum volume restrictions) at any time up to a cut-off point prior to the opening of continuous trading. These orders represent commitments to trade at the realized VWAP that is calculated after the close of the continuous trading session. Immediately after the cut-off time, and prior to the opening of continuous trading, VWAP buyers and sellers are matched against one another, and the resulting match quantities are reported back to the traders as locked-in commitments to trade. Traditionally the matching priority is based upon the trader's class or the time of entry. Thus, prior to the opening of continuous trading, a VWAP trader will know exactly how many shares he will transact at the VWAP, but will not know the price a priori. At the conclusion of the continuous trading session, the VWAP is calculated, the VWAP trades (price and quantities) are reported to the respective traders, and such trades are printed to the appropriate trade tape. Like crossing networks (e.g., POSIT, E-Crossnet), VWAP trading is inherently a parasitically priced trading mechanism, which depends upon the computation of the trading price from the continuous market.

Crossing networks determine their reference price for trading as the midpoint price of the bid/ask spread, sampled at a random instant within a pre-defined time interval in order to deter gaming. However, since the VWAP represents a weighted average price over time, VWAP trading has typically spanned an entire trading session (e.g., all day, or morning/afternoon sessions). This practice has its origin in two aspects of trading: first, VWAP traders are presumed to be “information less” traders who have no basis for intra-day timing of their trading strategies in an attempt to improve their average price; thus they are willing to accept the daily VWAP on the assumption that their attempts to time their trades intra-day would prove fruitless; and second, today's markets are predominantly continuous markets, and the trading rules and conventions (e.g., price/time priority and trade-through prohibitions, market linkages and trade reporting requirements, etc.) are predicated upon a continuous trading paradigm.

With further reference to the liquidity database maintained according to the present disclosure, the liquidity database stores data/information as to how many shares engine 104 can currently buy or sell for each symbol eligible to trade in the engine. Generally, the form of such liquidity data/information is: <Symbol: Session: Buy_Size×Sell_Size>. According to preferred embodiments of the present disclosure, engine 104 automatically updates the buy_size and sell_size using algorithms that are designed to look at historical market data for the symbol, trading performance of the disclosed system for that symbol, and/or other parameters relevant to such determination. The system decrements the buy_size or sell_size as customer orders are matched against the liquidity database. The system increments the buy_size or sell_size if crosses of customer orders “free up” previous committed liquidity. In further preferred embodiments of the present disclosure, algorithms may be used to determine whether to impose a reduction in buy_size×sell_size liquidity within the liquidity database as the trading day progresses, based on the relative shortness of the remaining trading session.

Engine 104 further communicates with and responds to input from algorithmic modules associated with exemplary embodiments of the present disclosure, such algorithmic modules schematically illustrated as algorithmic module 130. In particular, algorithmic module 130 generally includes a “math module” or “approximation engine” that is programmed to determine how much to trade into the market every “x” minutes, and an “iBroker module” that is programmed to determine how, when and where to trade the volume specified by the math module during the “x” minutes allotted to implementing the trade.

According to preferred embodiments, the math module within algorithmic module 130 employs sophisticated mathematical techniques to achieve VWAP pricing for orders it receives in connection with each session of the day. For example, the math module may produce “child orders” and route them to the market. A “child order” may be defined as an order created by the math module and sent for execution, in an attempt to fill the parent VWAP order. An exemplary algorithmic approach for developing advantageous child orders may be described as follows.

For each time slice in which a VWAP order is active, engine 104 will produce one or more child orders, the total volume of which will be determined by the following formula:

V_{trade}=V_{left}*(Vᵢₙₜₑᵣᵥₐₗ/V_{remaining})

Where:

Vᵢₙₜₑᵣᵥₐₗ is the number of shares of the specified security the market is expected to trade in the current interval;

V_{remaining} is the number of shares of the specified security the market is expected to trade in the full day;

V_{left} is the number of shares remaining to be traded in the VWAP order; and

V_{trade} is the calculated total number of shares to be traded in child orders in this interval. (Of note, the math module will not attempt to trade a volume larger than the contra quote.)

According to this exemplary algorithmic approach, the values of Vᵢₙₜₑᵣᵥₐₗ and V_{remaining} are calculated from security-specific trade history files. These files may be updated on a daily basis and corrected intra-day. The math module may provide a facility to allow for period by period modifications to the value of Vᵢₙₜₑᵣᵥₐₗ so authorized personnel can provide current estimates of the trading volume as predicted by proprietary techniques.

Once V_{trade} has been calculated for a given interval, a determination must be made as to how to divide this volume into multiple child orders. The goal is to minimize the risk of not getting the trade executed, while maximizing the chance of getting a better than market average execution price. To this end, a relatively large percentage of V_{trade} will be submitted to the market priced at the midpoint between the bid and the offer. The remaining volume of V_{trade} will be submitted to the market in multiple child orders at less aggressive prices.

During the interval, the math module advantageously tracks the degree to which it is achieving the desired volumes in each interval. If the executed volumes are insufficient, the math module shifts the child orders towards the contra quote. In addition, the math module tracks the market and shifts in a non-aggressive fashion if the market is heavily imbalanced in a way that indicates it is moving in a favorable direction.

The math module also tracks orders at the aggregate and individual order levels and determines how much to trade into the market every “x” minutes to come close to achieving the VWAP given the dynamic market conditions and past history of the symbol and market. The math module automatically implements crossing of orders when it receives opposing orders from engine 104, and implements cancellation of orders by determining the fill and price of the fill as of the next minute upon receiving the cancel request. The math module also automatically adjusts its cross and aggregate trading positions after the cancel is implemented and the unfilled portion of the order is returned to the customer, and responds to a “What If Cancel” request from engine 104 for orders or list of orders, by determining the fill and price of fill for a cancel; without actually implementing the cancel. In addition, the math module automatically adjusts its trading strategy to late opens, market halts, and downtime due to system recovery scenarios.

In response to market conditions and/or developments, the math module automatically adjusts its trading strategy to widely fluctuating market and symbol conditions to achieve as close as possible VWAP pricing, utilizing electronic trading data from SIAC 134 and/or SOES 136 that is received through market gateway 132. Market gateway 132 advantageously receives raw real-time data directly from SIAC and Nasdaq market feeds, processes this real-time data and provides processed data to engine 104 and algorithmic module 130 for use by the math module and the iBroker module, as appropriate. Market gateway 132 additionally stores raw historical data to provide processed and historical data, as needed, to the foregoing system components.

The iBroker module, in turn, receives requests from the math module (via engine 104) to trade (i.e., buy or sell) “N” shares of symbol “S” every “x” minutes. The iBroker module is programmed to monitor and analyze certain market conditions received via market gateway 132 to determine/decide upon execution, order type(s) and timing of child orders created from the initial order, thereby optimizing execution of the “N” shares initiated by the math module.

According to preferred embodiments of the disclosed system/method, a “monitor module” is also provided that delivers multiple real-time views of relevant information. For example, in an exemplary embodiment, the monitor module provides: (1) a management and operational view; (2) a risk and alerts view; (3) a math package view; and (4) an event view. The management and operational view provides real-time data to managers and operational staff with regard to net capital and profit/loss (P&L) considerations. The risk and alerts view provides real-time data to technical and operational staff with regard to the health and well-being of engine 104 and the entire system, as disclosed herein. The math package view provides real-time data to technical staff specialized in the math module specifications, e.g., with regard to expected performance levels given current market conditions. The event view provides real-time data with regard to any new orders and cancelled orders, because the receipt of a new order or cancellation is generally considered to be an event by the system.

At the end of the trading day, engine 104 computes guaranteed VWAP prices and best-efforts VWAP prices for each session and symbol that there were customer orders. Engine 104 disseminates final fills to all customers and trades are reported to tape and back-office systems for internal reconciliation, e.g., to a billing/accounting function 112 and trade reporting function 114. Of note, according to preferred embodiments of the present disclosure, final transactions (trades) due to user cancellations are reported to tape in close temporal proximity to the cancellation time, rather than at the end of day. Clearing and settlement of trades may be implemented by a trade clearing function 118 with which engine 104 communicates through an order execution interface 116, and reconciled in a back office operation, e.g., trade reconcile function 115. Communications with brokers 122a, 122b, 122c are advantageously transmitted by way of a FIX interface gateway 120, as is known in the art.

Thus, the disclosed system/method provides in effect a back office module that collects all transactions on the customer side and the iBroker trading side, and creates the necessary back-office reports and messages to effect final settlement and clearing with customers and between engine 104 and its execution venues. The back office module ensures that messages and/or transmissions for proper, reporting to tape of final transactions are effectuated, and that reports for internal reconciliation and billing are created.

The disclosed system and method thus provide numerous distinct and important advantages as compared to prior art systems and methods. In particular, the disclosed system/method provides automated proprietary filling of a customer order at a guaranteed VWAP price insofar as: (i) the customer order is crossed with an opposite order; or (ii) the liquidity database determines that execution of the customer order at the VWAP complies with applicable regulatory and business limits imposed on the system. For orders filled in this manner, the customer is assured of a fill price based on a calculation derived from the market thereafter.

The disclosed system/method further provides automated agency filling of a customer order at a best-efforts VWAP price, insofar as a guaranteed VWAP price was not available. The degree to which the customer price differs from the actual VWAP price is minimized by operation of the algorithmic module which includes a math module and iBroker module. These algorithmic modules cooperate to respond to a variety of factors to deliver pricing that closely approximates (if not equals) the actual VWAP price. For orders filled in this manner, the customer gets a fill price based on actual trading by the system into the market and/or cross components of the order priced at the guaranteed VWAP.

In addition, the disclosed system/method is advantageously designed to provide VWAP prices for multiple-session “balance of day” intervals from 9:30 to close and every 15 minutes after 9:30 to close (e.g., 11:15 to close VWAP session). To take advantage of a given VWAP session, the customer orders must be received by a predetermined time (session call point) that is “x” minutes prior to the onset of the VWAP calculation interval. Thus, the system/method of the present disclosure provides both a pre-open crossing network and an intra-day crossing network

The disclosed system/method automatically aggregates all order flow at each session and advantageously detects and implements crosses of orders within sessions and between sessions (e.g., Buy 100K IBM at 9:30 & Sell 50K IBM at 11:00). Additionally, the system and method of the present disclosure automatically detects and implements crosses between guaranteed VWAP and best-efforts VWAP orders (e.g., Buy 100K IBM Guaranteed VWAP & Sell 75K IBM Best Efforts VWAP).

The disclosed system/method accepts full cancellation of orders prior to the call point. Moreover, the system/method of the present disclosure accepts cancellation of orders after the call point, and responds within a predetermined period of time, e.g., within one minute of the system's receipt of the cancellation. If the order was placed as a guaranteed VWAP order, the system/method returns “fill as of cancel” and “VWAP price as of cancel.” If the order was placed as a best efforts VWAP order, the system/method returns “actual fill as of cancel” and “best efforts price as of cancel.” If the cancelled order is part of a crossed set of orders, the system/method of the present disclosure automatically “un-crosses” the cross and auto-generates necessary order to fill contra side of cross that did not cancel. For example, if Sell 75K is cancelled at 11:09 and returns 50K “unfilled” to customer, then system automatically generates a buy 50K from 11:09 to close to ensure that the 100K order (contra side of the cross that is not cancelled) is not affected by the cancel.

The disclosed system/method also provides “what if cancel” solutions without actually implementing the cancel in the engine, and utilizes mechanisms to determine aforementioned “fills” and “prices” even if unusual circumstances arise, e.g., late opens (system still operating), market halts (system still operating), system downtime (market still operating) due to recovery process, market or symbol fluctuates away from its normal statistical distribution, and/or odd lot orders are received, despite fact that natural crosses are at lot size increments of integral shares.

The disclosed system/method further optimizes “fill” liquidity to customers while meeting net capital requirements (with net capital haircuts minimized via business, technology, and regulatory mechanisms), and employs sophisticated VWAP calculation engine that computes point-to-point VWAP calculations in real-time, taking into consideration via a rule-based filtering mechanism: type of transaction, corrected transactions, sale condition, timestamp, market halts, late opens, special days (e.g. ½ days).

Although the system and method of the present disclosure have been described with respect to preferred embodiments, those skilled in the art will readily appreciate that changes and modifications may be made thereto without departing from the spirit and scope hereof as defined by the appended claims. For example, the subject matter of the present disclosure may benefit from and/or may be used in conjunction with the systems and methods described in a commonly assigned, co-pending patent application entitled “Volume Weighted Average Price Matching System for Crossing Network,” filed Apr. 10, 2000 and assigned Ser. No. 09/546,341, the entire content of which is hereby incorporated by reference.

What is claimed is:

1. A system for processing a user trade, comprising:
a processing engine in communication with an algorithmic module and a database, said database including a liquidity database, wherein said processing engine is programmed to automatically access said liquidity database to determine an acceptable quantity of shares for trading in response to, and based upon, a requested user trade received by said processing engine.

2. A system according to claim 1, wherein said requested user trade is communicated to said processing engine across a network interface.

3. A system according to claim 2, wherein said network interface facilitates communication with said processing engine using a FIX protocol.

4. A system according to claim 1, wherein said requested user trade is communicated to said processing engine in a predetermined format that includes an identification of a trading action, a trading symbol and a trading price.

5. A system according to claim 4, wherein said predetermined format further includes an identification of cancel option and trading session, and wherein said processing engine automatically applies a default value in the absence of a specified cancel option or trading session.

6. A system according to claim 5, wherein said default value is based upon user-specific information contained in said database.

7. A system according to claim 1, wherein said processing engine automatically aggregates requested user trades based upon subject security and crosses of user trades.

8. A system according to claim 1, wherein said processing engine provides guaranteed VWAP pricing based upon a trading determination derived from said liquidity database.

9. A system according to claim 1, wherein said processing engine automatically processes trades during predetermined trading sessions of predetermined duration.

10. A system according to claim 9, wherein said requested user trade identifies a desired predetermined trading session from among said predetermined trading sessions for execution of said requested user trade.

11. A system according to claim 1, wherein said processing engine automatically processes a cancellation request received in connection with a requested user trade.

12. A system according to claim 11, wherein said processing engine automatically processes said cancellation request only if said cancellation request is received a predetermined period of time prior to commencement of an identified trading session.

13. A system according to claim 1, wherein said algorithmic module includes programming for establishing a trading regimen for effecting trades that approach or achieve a VWAP price for best efforts VWAP trades.

14. A method for processing a user trade, comprising:
(a) enrolling a user for utilization of a processing engine, said enrollment including storage of relevant enrollment information in an enrollment database;
(b) receiving a requested user trade from an enrolled user in a predetermined format;
(c) automatically determining a quantity of shares that may be traded at a VWAP price in response to said requested user trade based upon information derived from a liquidity database;
(d) filling a quantity of shares at the VWAP price based upon said liquidity database-based determination.

15. A method according to claim 14, wherein said enrollment step includes a credit risk determination with respect to a potential enrollee.

16. A method according to claim 14, further comprising updating said liquidity database to reflect completed user trades.

17. A method according to claim 14, further comprising revising said liquidity database based on one or more external factors.

18. A method according to claim 17, wherein said one or more external factors are selected from the group consisting of historical market data for said shares, historical trading performance with respect to said shares, time remaining in trading session, and time remaining in trading day.

19. A method according to claim 14, further comprising automatically detecting and implementing crosses between requested user trades.

20. A method according to claim 14, further comprising algorithmically determining a trading regimen for a quantity of shares that are not filled at the VWAP price based upon said liquidity database-based determination, said trading regimen aimed at achieving a VWAP price for said non-filled quantity of shares.
